(19) United States
(12) Patent Application Publication
(10) Pub. No.: US 2025/0023158 A1
(43) Pub. Date: Jan. 16, 2025

(54) SECONDARY BATTERY AND MANUFACTURING EQUIPMENT FOR THE SAME

(71) Applicant: SAMSUNG SDI CO., LTD., Yongin-si (KR)

(72) Inventor: Ho Seong KIM, Yongin-si (KR)

(21) Appl. No.: 18/609,399

(22) Filed: Mar. 19, 2024

(30) Foreign Application Priority Data
Jul. 13, 2023 (KR) 10-2023-0091150

(51) Int. Cl. H01M 50/152; H01M 50/531

(52) U.S. Cl. CPC H01M 50/152; H01M 50/531

(57) ABSTRACT

A secondary battery includes an electrode assembly having a positive electrode plate, a negative electrode plate, and a separator disposed between the positive electrode plate and the negative electrode plate. The secondary battery further includes a case surrounding the electrode assembly, the case including a case body portion that has a recess for accommodating the electrode assembly and a case cover that covers and seals the recess of the case body portion, the recess having a plurality of side surfaces, and a first side surface among the plurality of side surfaces has a first line that is a concave curve in a direction of the recess and a second line that is a straight line opposite the first line.

### CROSS-REFERENCE TO RELATED APPLICATION

This application claims priority to and the benefit of Korean Patent Application No. 10-2023-0091150 filed on Jul. 13, 2023, in the Korean Intellectual Property Office, the entire disclosure of which is incorporated herein by reference.

### BACKGROUND

### 1. Field

Embodiments of the present disclosure relate to a secondary battery and manufacturing equipment for the same.

### 2. Description of the Related Art

A secondary battery is a power storage system that provides excellent energy density capable of converting electrical energy into chemical energy and storing the same. Compared to non-rechargeable primary batteries, secondary batteries are rechargeable and are widely used in IT devices such as smart phones, cellular phones, notebooks, and tablet PCs. Recently, interest in electric vehicles has increased to prevent environmental pollution, and accordingly, high-capacity secondary batteries are being adopted for electric vehicles. These secondary batteries are required to have characteristics such as high density, high power, and stability.

The above information disclosed in this Background section is only for enhancement of understanding of the background of the disclosure.

### SUMMARY

Embodiments include a secondary battery including an electrode assembly having a positive electrode plate, a negative electrode plate, and a separator disposed between the positive electrode plate and the negative electrode plate. The secondary battery further includes a case surrounding the electrode assembly, the case including a case body portion that has a recess for accommodating the electrode assembly and a case cover that covers and seals the recess of the case body portion, the recess having a plurality of side surfaces, and a first side surface among the plurality of side surfaces has a first line that is a concave curve in a direction of the recess and a second line that is a straight line opposite the first line.

The electrode assembly may further include a positive electrode lead tab that is in contact with the positive electrode plate and protrudes to the one side of the electrode assembly to protrude to the outside of the case and a negative electrode lead tab that is in contact with the negative electrode plate and protrudes to the one side of the electrode assembly to protrude to the outside of the case.

In the case, the first side surface is a side surface facing a second side surface on which the positive electrode lead tab and the negative electrode lead tab protrude.

The secondary battery may further include a folding portion between the case body portion and the case cover.

The first side surface may be a surface of the recess adjacent to the folding portion, and the second line is a part of the folding portion.

The recess may have a seating surface parallel to the case cover and four side surfaces extending from the seating surface toward the case cover, and the first line of the first side surface may be a line that is in contact with the seating surface.

The case body portion may further include a sealing portion extending outward from the recess provided in a center region and the sealing portion is parallel to and coupled to the case cover.

The sealing portion may extend in an outward direction from a second side surface, third side surface, and fourth side surface of the recess.

The case cover may be folded through the folding portion and coupled to the sealing portion.

A second side surface, third side surface, and fourth side surface of the recess may be flat surfaces.

The first line may be disposed on the lower side of the case body portion so as to

face the case cover, and the second line is disposed at the same height as the sealing portions disposed on the edges of the plurality of side surfaces.

The side surfaces may include a second side surface facing the first side surface, a third side surface connecting the first side surface and the second side surface, and a fourth line facing the third side surface and connecting the first side surface and the second side surface.

The first line and the electrode assembly accommodated in the recess may be spaced apart from each other by a first distance, the second line and the electrode assembly accommodated in the recess may be spaced apart from each other by a second distance and the first distance may be smaller than the second distance.

A center region of the first line may include a curve and an edge region of the first line may be a straight line.

The electrode assembly may be in the form of a jelly roll in which the positive electrode plate, the separator, the negative electrode plate, and the separator are stacked and then wound.

The electrode assembly may be a stacked electrode assembly in which the positive electrode plate, the separator, the negative electrode plate, and the separator are sequentially stacked.

An insulating tape may be interposed for insulating between the negative electrode lead tab and the case, and the insulating tape may be interposed for insulating the positive electrode lead tab and the case from each other.

Manufacturing equipment for manufacturing the case of the secondary battery may include a die having a flat upper surface and an opening on an opposite side from the upper surface and having a rectangular shape in a plan view and a punch that can be inserted into the opening of the die and has a transition curve in a plan view.

The recess may be formed by placing a rectangular film for a secondary battery case on the upper surface of the die and then pressing the same with the punch.

In the recess, the first line of the first side surface may have a shape corresponding to a curved outer surface of the punch.

### BRIEF DESCRIPTION OF DRAWINGS

Features will become apparent to those of skill in the art by describing in detail exemplary embodiments with reference to the attached drawings in which:

FIG. 1 is a perspective view showing an example of a secondary battery, according to one or more embodiments;

FIG. 2 is an exploded perspective view of the secondary battery shown in FIG. 1, according to one or more embodiments;

FIG. 3 is a perspective view showing a case in an example of a secondary battery, according to one or more embodiments;

FIG. 4 is a diagram illustrating manufacturing equipment for manufacturing a secondary battery, according to one or more embodiments;

FIGS. 5A to 5C are diagrams for explaining a process in which the shape of a case is transformed in a secondary battery according to one or more embodiments;

FIG. 6 is an exploded perspective view showing an example of an electrode assembly applicable to a secondary battery, according to one or more embodiments;

FIG. 7 is a perspective view showing an example of an electrode assembly applicable to a secondary battery, according to one or more embodiments; and

FIG. 8 is an exploded perspective view showing another example of an electrode assembly applicable to a secondary battery according to one or more embodiments.

### DETAILED DESCRIPTION

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Examples of the present disclosure are provided to more completely explain the present disclosure to those skilled in the art, and the following examples may be modified in various other forms.

As used herein, the term “and/or” includes any and all combinations of one or more of the associated listed items. In addition, it will be understood that when an element A is referred to as being “connected to” an element B, the element A can be directly connected to the element B or an intervening element C may be present therebetween such that the element A and the element B are indirectly connected to each other.

The terminology used herein is for the purpose of describing particular embodiments only and is not intended to be limiting of the disclosure. As used herein, the singular forms are intended to include the plural forms as well, unless the context clearly indicates otherwise. It will be further understood that the terms that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present disclosure.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the element or feature in the figures is turned over, elements described as “below” or “beneath” other elements or features would then be oriented “on” or “above” the other elements or features. Thus, the exemplary term “below” can encompass both an orientation of above and below.

Hereinafter, embodiments of the present disclosure will be described in detail with reference to the accompanying drawings.

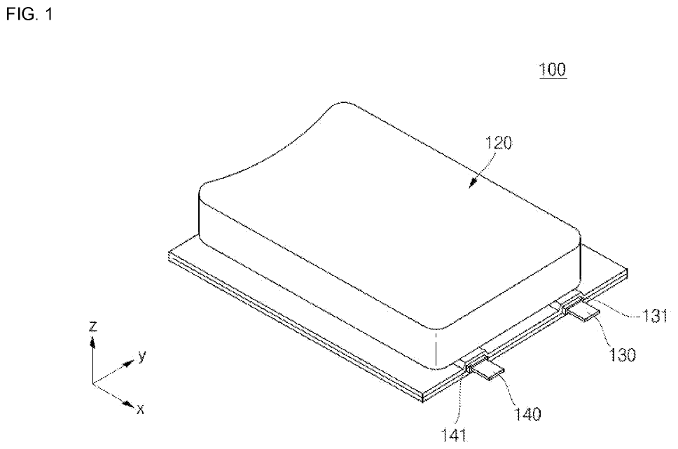

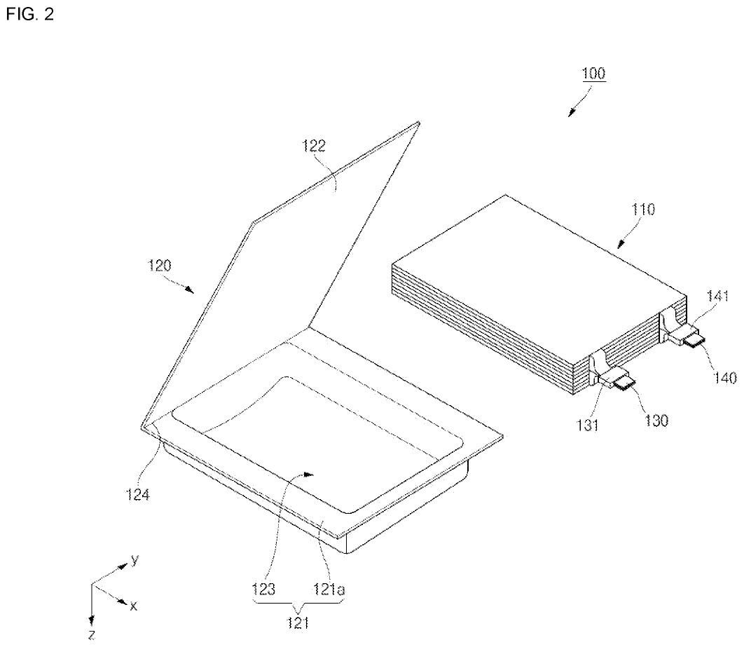

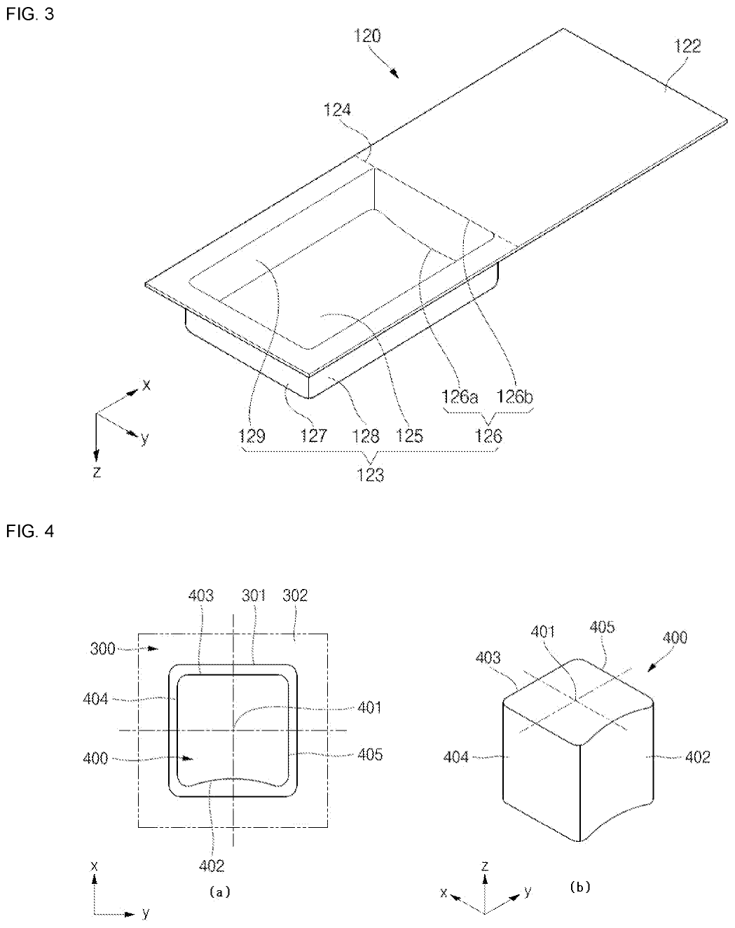

FIG. 1 is a perspective view showing an example of a secondary battery, according to one or more embodiments. FIG. 2 is an exploded perspective view of the secondary battery shown in FIG. 1, according to one or more embodiments. FIG. 3 is a perspective view showing a case in an example of a secondary battery, according to one or more embodiments.

Referring to FIGS. 1 to 3, the secondary battery 100 may include an electrode assembly 110 and a case 120.

The electrode assembly 110 may be accommodated inside the case 120 together with an electrolyte. The electrolyte may be made of, in one or more embodiments, lithium salts such as LiPF6, LibF4, etc. in an organic solvent such as, for example, ethylene carbonate (EC), propylene carbonate (PC), diethyl carbonate (DEC), ethyl methyl carbonate (EMC), and dimethyl carbonate (DMC).

The electrode assembly 110 may include a negative electrode plate as a first electrode plate, a positive electrode plate as a second electrode plate, and a separator interposed therebetween. A positive electrode lead tab 130 electrically connected to the positive electrode uncoated portion may be provided in the positive electrode plate and a negative electrode lead tab 140 electrically connected to the negative electrode uncoated portion may be provided in the negative electrode plate. The negative electrode lead tab 140 and the positive electrode lead tab 130 may be electrically connected to the outside by, for example, being welded to the negative and positive electrode leads of the external terminal. A first insulating tape 141 for insulating from the case 120 may be attached to the negative electrode lead tab 140 and a second insulating tape 141 for insulating from the case 120 may be attached to the positive electrode lead tab 130.

The case 120 may include a case body portion 121 and a case cover 122 in which a rectangular film extending in a first direction (x), which is the first direction of the case 120, is folded.

In addition, in the case 120, the electrode assembly 110 may be accommodated in a recess 123 provided in the case body portion 121, and then the case cover 122 may be folded to couple and seal the case body portion 121. In an example embodiment, the case 120 may be referred to as a pouch for a secondary battery.

The case 120 may be formed by folding a rectangular film extending along the first direction (x) on the basis of the folding portion 124 extending along a second direction (y) that is perpendicular to the first direction (x) and is the width direction of the case 120. In some embodiments, the case body portion 121 and the case cover 122 may be made of individual members, and in this case, the folding portion 124 may not be provided. In the present disclosure, the case 120 is not limited to an integrated case in which the case body portion 121 and the case cover 122 are formed on a single film. However, for convenience of explanation, the following description will be given by way of example in which the case body portion 121 and the case cover 122 are formed on a single rectangular film.

The case cover 122 may have a rectangular flat shape. The case cover 122 may be connected to the case body portion 121 through a folding portion 124. The case cover 122 may cover the upper part of the case body portion 121.

In addition, the case body portion 121 may include a recess 123 and a sealing portion 121a. The case body portion 121 may be provided with the recess 123 in which the electrode assembly 110 is accommodated approximately at the center, and may include the sealing portion 121a extending approximately outward from three sides of the recess 123. In one or more embodiments, the sealing portion 121a may extend outward from the four sides of the recess 123. The sealing portion 121a may be a surface parallel to and coupled to the case cover 122. In an example embodiment, when the case body portion 121 and the case cover 122 are made of separate members, the sealing portion 121a may also be provided in the region where the folding portion 124 is located. Of course, even when the case body portion 121 and the case cover 122 are integrated, the sealing portion 121a may also be provided in the case body portion 121 adjacent to the folding portion 124. However, for convenience of explanation, the following description will be given with respect to an embodiment where the case body portion 121 adjacent to the folding portion 124 is not provided with the sealing portion 121a.

The case cover 122 and the case body portion 121 may be formed of a multilayer thin film consisting of a metal thin film and an insulating layer formed on one side and the other side of the metal thin film, respectively. In the case cover 122 and the case body portion 121, the side on which the case cover 122 and the case body portion 121 are in contact with each other may be defined as the inner side and the opposite side thereof may be defined as the outer side.

The recess 123 of the case body portion 121 may be formed to a size enough to accommodate the electrode assembly 110 through pressing or drawing. In the case body portion 121, after the case cover 122 covers the portion where the recess 123 is formed, the edge of the recess 123 and the edge of the case cover 122 may be bonded to each other, e.g., thermally bonded. After the electrode assembly 110 is accommodated in the recess 123, the case 120 may be sealed by sealing the edge region of the case body portion 121 and the edge region of the case cover 122. For convenience, the edge of the main body portion 121 located outside the recess 123 that is sealed with the edge of the case cover 122 in a plan view is defined as the sealing portion 121a. A thermal fusion layer made of a thermally fusible material may be formed on the inner surface of the case 120. The recess 123 may be approximately parallel to the case cover 122, and may include a rectangular seating surface 125 which is approximately parallel to the case cover 122 and on which the electrode assembly is seated, and four side surfaces 126, 127, 128, and 129 extending from the four sides of the seating surface 125 toward the sealing portion 121a and/or the folding portion 124, respectively. A specific shape of the recess 123, in one or more embodiments, will be described in detail below.

The thermal fusion layer may be made of a material having insulating and thermal adhesive properties, and may be commonly referred to as a laminate exterior material. The thermal fusion layer may be formed entirely on the inner surface of the case 120, or may be formed only on the inner surface of the sealing portion 121a and the case cover 122. When the sealing portion 121a and the case cover 122 come into contact with each other to be thermally fused, the insulating tapes 131 and 141 of the positive electrode lead tab 130 and the negative electrode lead tab 140 may be interposed between the sealing portion 121a and the case cover 122.

FIG. 4 is a diagram illustrating manufacturing equipment for manufacturing a recess 123 in a case 120 of a secondary battery according to one or more embodiments. FIG. 4(a) is a plan view of manufacturing equipment, and FIG. 4(b) is a perspective view showing a punch in manufacturing equipment.

Referring to FIG. 4, the manufacturing equipment may include a die 300 and a punch 400.

The die 300 may have a substantially flat plate shape and may be provided with a square opening 301 in a plan view at approximately the center through which the punch 400 can move. In some embodiments, an opening 301 of the die 300 may be a cavity having a certain depth on the opposite side from the upper surface 302. An upper surface 302 of the die 300 may be a surface on which a rectangular film for forming the flat case 120 for forming the recess 123 is seated. In embodiments, the die 300 may have four sides that are substantially flat to provide the openings 301.

The punch 400 may include a first surface 401 having a flat rectangular shape and four side surfaces extending from four sides of the first surface. In one or more embodiments, the first surface 401 may be a rectangle having rounded corners. Further, the first surface 401 may be shaped to correspond to the seating surface 125 of the recess 123 in a plan view. In some embodiments, the punch 400 may be smaller in planar size so as to be inserted within the opening 301 of the die 300. In addition, the punch 400 may include four side surfaces 402, 403, 404, and 405 extending from four sides of the first surface 401. The first surface 401 may be referred to herein as the processing surface of the punch 400.

Among the four side surfaces of the punch 400, the first punch side surface 402 may be formed as a concave curved surface in the center direction on a plane. As another example, the first punch side surface 402 may have a curved center region and a flat edge region extending from the center region in the first direction (x).

In some embodiments, among the four side surfaces of the punch 400, the side surfaces 403, 404, and 405, excluding the first punch side surface 402, may be flat planes. In embodiments, the punch 400 may have a uniform and identical cross section cut perpendicular to a third direction (z).

In the case 120, after a rectangular film is seated on the upper surface 302 of the die 300, the region corresponding to the case body portion 121 may be pressed through the punch 400, thereby providing the recess 123. The punch 400, in one or more embodiments, may be inserted into the opening 301 of the die 300 when processing the recess 123.

In some embodiments, the first side surface 126 of the recess 123 formed by the first punch side surface 402 of the punch 400 may have a side adjacent to the folding portion 124 formed as a straight line and the side that is one side of the seating surface 125 may be curved. The recess 123 may include a seating surface 125 parallel to the case cover 122 and may have a rectangular shape and four side surfaces 126, 127, 128, and 129 extending from the four sides of the seating surface 125 toward the sealing portion 121a and/or the folding portion 124. The four side surfaces of the recess 123 may be considered herein as the four side surfaces of the case 120.

In the first side surface 126, the first line 126a in contact with the seating surface 125 may have a concave curved shape toward the center of the seating surface 125. The first line 126a may be shaped to correspond to the first punch side surface 402. In addition, in the first side surface 126, the second line 126b in contact with the folding portion 124 may have a straight shape. The second line 126b may be shaped to correspond to the straight line of the opening 301 of the die 300. In some embodiments, the first side surface 126 may be a side surface opposite to the second side surface 127 from which the positive electrode lead tab 130 and the negative electrode lead tab 140 of the electrode assembly 110 protrude from the case 120. In some embodiments, the first side surface 126 may face the second side surface 127 from which the positive electrode lead tab 130 and the negative electrode lead tab 140 protrude. In addition, the third side surface 128 and the fourth side surface 129 may connect the first side surface 126 and the second side surface 127.

In the first side surface 126, in some embodiments, part of the first line 126a may be curved and part may be straight. In an example embodiment, the center region of the first line 126a may have a curved shape and the edge regions extending from the center region to both sides along the second direction (y) may have a straight shape.

The first side surface 126, the second side surface 127, the third side surface 128, and the fourth side surface 129 may be arranged to surround the recess 123. In some embodiments, in the case 120 that does not include a curve, the second side surface 127, the third side surface 128, and the fourth side surface 129 may be flat planes without a curve. In other embodiments, the third side surface 128 and the fourth side surface 129 of the case 120 may also be formed to correspond to the first side surface 126 so that one side has a straight line and the other side has a curve.

The first line 126a may be a curve that is bent toward the recess 123. The first line 126a may be one side of the seating surface 125 of the recess 123 facing the case cover 122. The first line 126a may be closer to the electrode assembly 110 accommodated in the recess 123 than other side surfaces.

The second line 126b may be a side of the first side surface 126 disposed opposite to the first line 126a. The second line 126b may be a side adjacent to the case cover 122 compared to the first line 126a. The second line 126b may be a straight line disposed at the same height as the sealing portion 121a. In addition, the second line 126b may be disposed at the same position as the folding portion 124; that is, the second line 126b may be part of the folding portion 124.

By the first line 126a and the second line 126b, part of the first side surface 126 may include a curved surface and the remaining side of the first side surface 126 may include a straight line.

In the secondary battery 100 according to one or more embodiments, the first side surface 126 of the case 120 facing the rear surface of the electrode assembly 110 may include a curve, and thus, a space between the recess 123 and the electrode assembly 110 can be reduced.

The first line 126a, and the electrode assembly 110 accommodated in the recess 123, may be spaced apart from each other by a first distance, and the second line 126b, and the electrode assembly 110 accommodated in the recess 123, may be spaced apart from each other by a second distance. In one or more embodiments, the first distance may be smaller than the second distance. Accordingly, as charging and discharging of the secondary battery 100 progresses, a lower side suction phenomenon that may be caused by internal gas and electrolyte can be improved. The lower side suction refers to a phenomenon that in the case 120, the positive electrode lead tab 130 and the negative electrode lead tab 140 are swollen convexly by gas and electrolyte on the side surface opposite to the protruding surface and are then bulged toward the electrode assembly 110 to adhere thereto or be inhaled. Deformation due to the lower side suction may occur most often on the opposite side of the electrode assembly 110 where the positive electrode lead tab 130 and negative electrode lead tab 140 protrude.

By including the first line 126a that is concave in the inner direction, the first side surface 126 of the case 120 may reduce the internal space, and thus the shape deformation that occurs during repeated charging and discharging can be minimized.

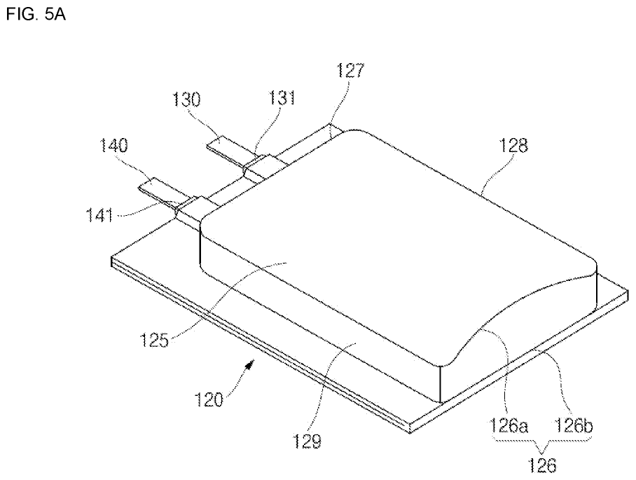

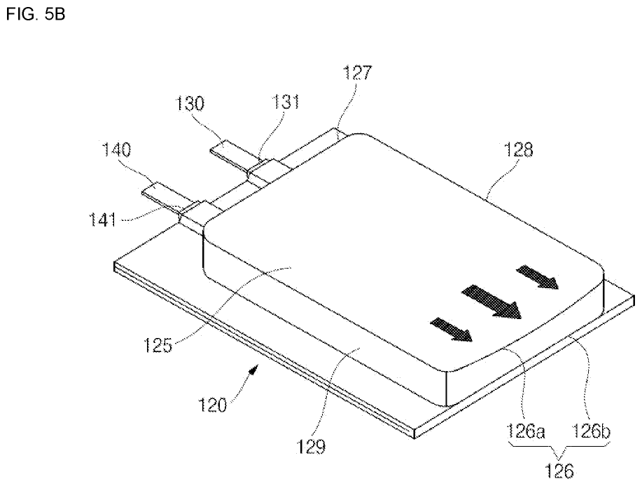

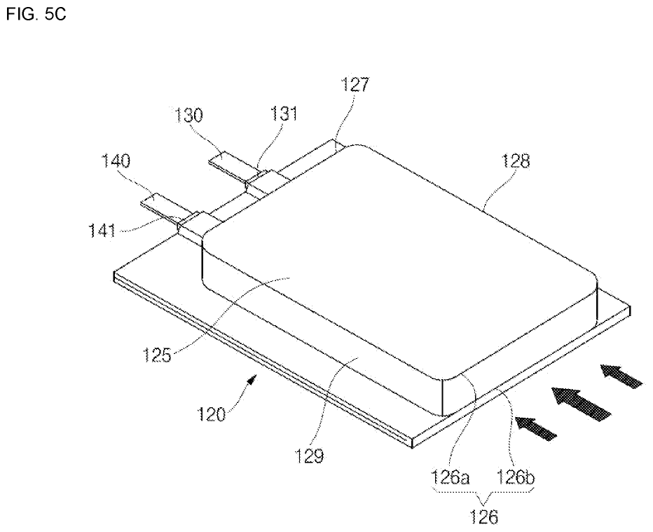

FIGS. 5A to 5C are diagrams for explaining a process in which the shape of a case is transformed in a secondary battery according to an embodiment.

Referring to FIG. 5A, the first side surface 126 of the case 120 manufactured using the manufacturing equipment shown in FIGS. 4(a) and 4(b) may include a first line 126a that is curved toward the recess 123 in which the electrode assembly 110 is accommodated.

The first line 126a may be inwardly bent toward the recess 123 relative to the second line 126b. However, even in this case, the first line 126a may be spaced apart from the electrode assembly 110 accommodated in the recess 123.

The remaining side surfaces 127, 128, and 129 of the case 120 that do not have curves may be formed to have flat surfaces.

Referring to FIG. 5B, the initial charging of the secondary battery may cause formation of a film on the surface of the negative electrode in the electrode assembly 110. During this process, gas may be generated from the electrode assembly 110. The first side surface 126 of the case 120 may be bent toward the outside of the case 120 by the gas generated in the electrode assembly 110, and as a result, the case including the first line 126a, the first side surface 126 of the case 120, including the first line 126a, may partially protrude to the outside of the case 120. Specifically, the first line 126a may be outwardly bent away from the case 120 and partially protrude to the outside of the case 120 relative to the second line 126b. In an embodiment, the first side surface 126 of the case 120 may be inwardly concavely formed, resulting in the reduction of the internal space, and thus may protrude less than the case 120 in which the entire side surface is flat. That is, since the first side surface 126 of the case 120 includes the first line 126a curved toward the recess 123, deformation due to gas and electrolyte can be reduced.

Referring to FIG. 5C, as the charging/discharging cycle of the electrode assembly 110 progresses later, the electrolyte around the electrode assembly 110 may flow into/wet into the interior of the electrode assembly 110. In embodiments, by the first line 126a, the first side surface 126 of the case 120 minimizes deformation during charging, and thus deformation of the shape due to bottom sucking can also be improved. In this way, a tape can be easily attached to the outside of the secondary battery 100 by minimizing deformation of the case 120.

In the secondary battery 100 according to one or more embodiments, as compared to a case having all side surfaces flat, the amount of deformation of the case 120 can be reduced by the gas generated from the electrode assembly 110. This is because the first side surface 126 of the case 120 includes a curve that is bent toward the recess 123. In addition, even if the case 120 is inwardly deformed as the charging/discharging cycle of the electrode assembly 110 progresses, the internal space of the case 120 may be reduced, thereby minimizing the deformation.

Hereinafter, the structure of the electrode assembly in the secondary battery according to one or more embodiments will be described in more detail.

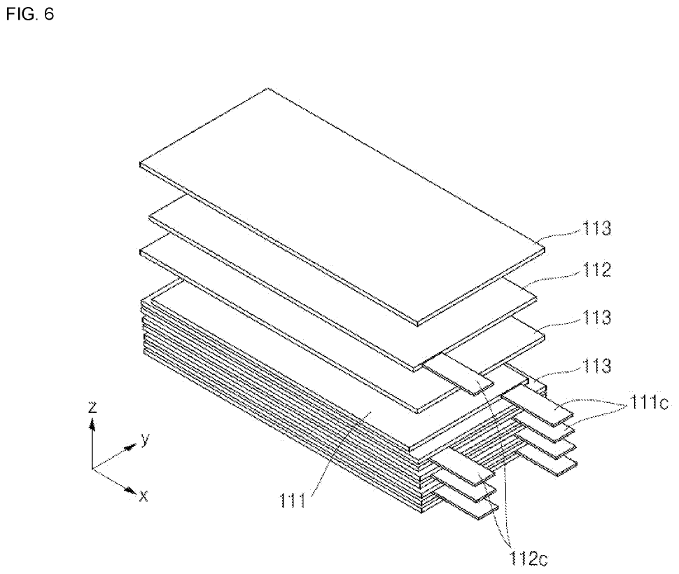

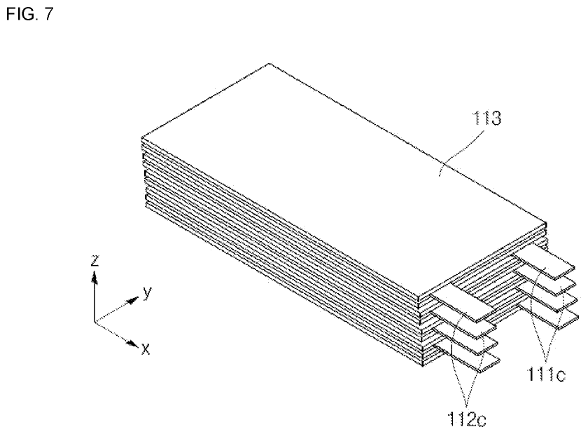

FIG. 6 is an exploded perspective view showing an example of an electrode assembly applicable to a secondary battery according to an embodiment, and FIG. 7 is a perspective view showing an example of an electrode assembly applicable to a secondary battery according to an embodiment.

As shown in FIGS. 6 and 7, the electrode assembly 110 may include a negative electrode plate 112 and a positive electrode plate 111, and a separator 113 interposed between the negative electrode plate 112 and the positive electrode plate 111. In some embodiments, the electrode assembly 110 may be a stack type in which a stack of the negative electrode plate 112, the separator 113, and the positive electrode plate 111 may be repeatedly stacked multiple times. In other embodiments, the electrode assembly 110 may be in the form of a roll wound with a laminate of a negative electrode plate, a separator 113, and a positive electrode plate 111. The electrode assembly 110 is also commonly referred to as a jelly roll. In the present disclosure, the electrode assembly 110 is explained as an example in a wound form.

The electrode assembly 110 may be formed by sequentially stacking a positive electrode plate 111, a separator 113, and a negative electrode plate 112 formed in a thin plate or film shape in a rectangular parallelepiped shape. In one or more embodiments, the electrode assembly 110 may be formed in a rectangular parallelepiped shape by sequentially stacking the separator 113, the positive electrode plate 111, the separator 113, and the negative electrode plate 112 multiple times in the third direction (z).

The positive electrode plate 111 may be formed by applying a positive electrode active material, for example, graphite or carbon, to a positive electrode current collector plate formed of a metal foil, such as aluminum. In some embodiments, the positive electrode active material may be formed on one or both sides of the positive electrode current collector. In addition, the positive electrode current collector plate may include a positive electrode uncoated portion 111c, which is a region to which the positive electrode active material is not applied. In addition, the positive electrode uncoated portion 111c may be a positive electrode tab 111c, which is a passage for current flow between the positive electrode plate 111 and the outside of the positive electrode. The positive electrode tab 111c may protrude from one end of the positive electrode plate 111 in the first direction (x). In addition, the positive electrode tab 111c may be located at one end of the first direction (x) and at one end of the second direction (y). The positive electrode tabs 111c of a plurality of stacked positive electrode plates 111 may be aligned in the third direction (z) at the same position in the electrode assembly 110.

In addition, a plurality of positive electrode tabs 111c may be electrically connected to one positive electrode lead tab 130 and may extend and protrude from the inside to the outside of the case 120. The positive electrode lead tab 130 may have a flat plate shape in which the thickness thereof is larger than that of the positive electrode tab 111c. In addition, the insulating tape 131 may be further interposed between the positive electrode lead tab 130 and the case 120. The insulating tape 131 can ensure electrical insulation between the case 120 and the positive electrode lead tab 130.

As such, the positive electrode plate 111 may be formed by applying the positive electrode active material to a positive electrode current collector plate, which is a roll-shaped metal foil, and then separated into an individual positive electrode having one positive electrode tab 111c by punching. The positive electrode plate 111 may be made of various materials. In addition, in consideration of the lithium ion precipitation phenomenon that may occur intermittently in the negative electrode plate 112 during charging, the positive electrode plate 111 may be smaller in size than the negative electrode plate 112 in the first direction (x) and the second direction (y). That is, the negative electrode plate 112 may have a larger planar size than the positive electrode plate 111.

The positive electrode plate 111 may be formed, for example, by applying a positive electrode active material to both sides of a positive electrode current collector plate made of aluminum metal foil with excellent conductivity. As the positive electrode active material, a chalcogenide compound, for example, may be used, and as an example, complex metal oxides such as LiCoO2, LiMn2O4, LiNiO2, and LiNiMnO2, may be used. A positive electrode uncoated portion in which the positive electrode active material is not applied may be formed in some regions of the positive electrode current collector plate. The positive electrode tab 111c may be provided in the positive electrode uncoated portion to be electrically connected to the positive electrode uncoated portion. An insulating member may be attached to the positive electrode tab 111c to prevent the positive electrode tab 111c from being short-circuited with the case 120.

The negative electrode plate 112 may be formed by applying a negative electrode active material 112b, for example, a transition metal oxide to a negative electrode current collector plate formed of a metal foil such as copper or nickel, and may include a negative electrode uncoated portion 112c that is a region to which a second active material is not applied. The negative electrode uncoated portion 112c may be a negative electrode tab 112c, which is a passage for current flow between the negative electrode plate 112 and the outside of the negative electrode. The negative electrode tab 112c may protrude from one end of the negative electrode plate 112 in the first direction (x). In addition, the negative electrode tab 112c may be located at one end in the first direction (x) and at the other end in the second direction (y), such that the negative electrode tab 112c may protrude in the same direction as the positive electrode tab 111c and may be arranged parallel to the positive electrode tab 111c. The negative electrode tabs 112c of the plurality of stacked negative electrode plates 112 may be aligned in the third direction (z) at the same position in the electrode assembly 110.

The negative electrode plate 112 may be formed by applying the negative electrode active material 112b to a second current collector plate, which is a roll-shaped metal foil, and then separated into individual negative electrode plates 112 having one negative electrode tab 112c by punching. The negative electrode plate 112 may be made of various materials.

In addition, a plurality of negative electrode tabs 112c may be electrically connected to one negative electrode lead tab 140 and may extend and protrude from the inside to the outside of the case 120. The negative electrode lead tab 140 may have a flat plate shape in which the thickness thereof is larger than that of the negative electrode tab 112c. In addition, an insulating tape 141 may be further interposed between the negative electrode lead tab 140 and the case 120. The insulating tape 141 can ensure electrical insulation between the case 120 and the negative electrode lead tab 140.

In embodiments, the negative electrode plate 112 may be formed by applying a negative electrode active material to both sides of a negative electrode current collector plate formed of a metal foil, for example, copper, a copper alloy, nickel, or a nickel alloy. As a negative electrode active material, for example, carbon-based materials, Si, Sn, tin oxide, tin alloy composite, transition metal oxide, lithium metal nitrite, or metal oxide may be used. A negative electrode uncoated portion may be formed in some regions of the negative electrode current collector plate, to which the negative electrode active material is not applied. The negative electrode tab 112c may be provided in the negative electrode uncoated portion to be electrically connected to the negative electrode uncoated portion. An insulating member may be attached to the negative electrode tab 112c to prevent the negative electrode tab 112c from being short-circuited with the case 120.

The separator 113 may be located between the positive electrode plate 111 and the negative electrode plate 112 and serves to prevent electrical short circuits and enable the movement of transition metal ions, and may be made of polyethylene, polypropylene, or a composite film of polyethylene and polypropylene. The separator 113 may be made of various materials.

In order to more securely prevent short circuits between the positive electrode plate 111 and the negative electrode plate 112, the separator 113 may be formed to have a larger width and a larger length than the positive electrode plate 111 and the negative electrode plate 112 in both the first direction (x) and the second direction (y). That is, the separator 113 may have a larger planar size than the positive electrode plate 111 and the negative electrode plate 112.

In addition, in the separator 113, the thickness of one end in the first direction (x) may be larger than the thicknesses of other regions. The separator 113 may have an insulating portion at one end in the first direction (x) in which, as a whole, the thickness thereof is larger than that of other regions. In one or more embodiments, the insulating portion may overlap with some regions of the positive electrode tab 111c and the negative electrode tab 112c in the third direction (z).

The insulating portion may overlap with the region of the positive electrode tab 111c, adjacent to the positive electrode current collector 111a, in the third direction (z), and may overlap with the region of the negative electrode tab 112c, adjacent to the negative electrode current collector 112a, in the third direction (z).

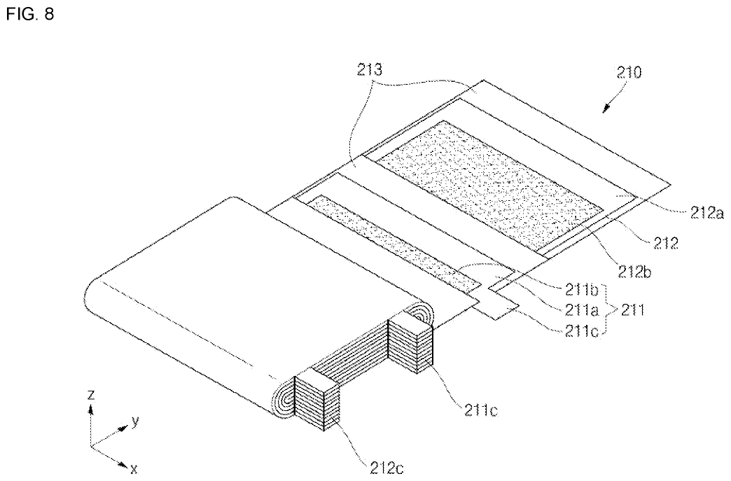

FIG. 8 is an exploded perspective view showing another example of an electrode assembly applicable to a secondary battery according to one or more embodiments.

The electrode assembly 210 shown in FIG. 8 may be formed by stacking a positive electrode plate 211, a separator 213, and a negative electrode plate 212, and then winding the stack in the form of a jelly roll.

In one or more embodiments, the positive electrode plate 211 may be formed by applying a positive electrode active material 211b, for example, a transition metal oxide, to a positive electrode current collector 211a that may be formed of a metal foil, for example, aluminum, and may include a positive electrode tab 211c that is a positive electrode uncoated portion 211c, which is a region to which the positive electrode active material 211b is not applied. As such, the positive electrode plate 211 may be formed by applying a positive electrode active material 211b to a positive electrode current collector 211a, which is a roll-shaped metal foil, and then forming a plurality of positive electrode tabs 211c by, for example, punching. The positive electrode tabs 211c may become passages for current flow between the positive electrode plate 211 and the outside of the positive electrode plate 211. The positive electrode tabs 211c may be formed at each turn of the wound electrode assembly 210 and may protrude a certain length in a first direction (x) parallel to the winding axis of the electrode assembly 210. A plurality of anode tabs 211c may be provided, and may be located at one end of the electrode assembly 210 in the first direction (x) and on one side in the second direction (y). The positive electrode tabs 211c of the wound positive electrode plate 211 may be aligned at the same position in the electrode assembly 210 in the third direction (z).

In one or more embodiments, the negative electrode plate 212 may be formed by applying a negative electrode active material 212b, for example, a transition metal oxide, to a negative electrode current collector 212a formed of a metal foil, for example, aluminum, and may include a negative electrode tab 212c that is a negative electrode uncoated portion 212c, which is a region to which the negative electrode active material 212b is not applied. As such, the negative electrode plate 212 may be formed by applying the negative electrode active material 212b to the negative electrode current collector 212a, which may be a roll-shaped metal foil, and then forming a plurality of negative electrode tabs 212c by, for example, punching. The negative electrode tabs 212c may become passages for current flow between the negative electrode plate 212 and the outside of the negative electrode plate 212. The negative electrode tabs 212c may be formed at each turn of the wound electrode assembly 210 and may protrude a certain length in the first direction (x) parallel to the winding axis of the electrode assembly 210. The negative electrode tabs 212c may be located at one end of the electrode assembly 210 in the first direction (x) and at the other end in the second direction (y). The negative electrode tabs 212c of the wound negative electrode plate 212 may be aligned at the same position in the electrode assembly 210 in the third direction (z).

The separator 213 may be located between the positive electrode plate 211 and the negative electrode plate 212 and serves to prevent electrical short circuits and enable the movement of transition metal ions, and may be made of, for example, polyethylene, polypropylene, or a composite film of polyethylene and polypropylene. The separator 213 may be made of various materials.

In order to more securely prevent short circuits between the positive electrode plate 211 and the negative electrode plate 212, the separator 213 may be formed to have a larger width and a larger length than the positive electrode plate 211 and the negative electrode plate 212 in both the first direction (x) and the second direction (y), such that the separator 113 may have a larger planar size than the positive electrode plate 111 and the negative electrode plate 112. That is, the separator 213 may have a larger planar size than the positive electrode plate 211 and the negative electrode plate 212.

In the separator 213, the thickness of one end in the first direction (x) may be larger than the thicknesses of other regions. In addition, the thickness of the other end in the first direction (x) may be larger than the thicknesses of other regions of the separator 213, except for the one end, or may be the same as the thickness of the one end in the first direction (x).

The present disclosure provides a secondary battery and manufacturing equipment for manufacturing the same, in which shape deformation may be minimized toward a recess that accommodates an electrode assembly.

As described above, in the secondary battery and the manufacturing equipment for the same, according to various embodiments of the present disclosure, by forming a first line of a first side surface of a recess accommodating an electrode assembly as a curve concavely formed toward the recess, a space between the electrode assembly and a case is minimized, thereby minimizing deformation of the case during charging and discharging.

In addition, in the secondary battery and the manufacturing equipment for the same, according to various embodiments of the present disclosure, deformation of the case can be minimized, and thus, a tape attached to the outside of the case can be prevented from detaching and defects resulting therefrom can be prevented.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery comprising:
an electrode assembly having a positive electrode plate, a negative electrode plate, and a separator disposed between the positive electrode plate and the negative electrode plate; and
a case surrounding the electrode assembly, the case including:
a case body portion that has a recess for accommodating the electrode assembly; and
a case cover that covers and seals the recess of the case body portion, the recess having a plurality of side surfaces, and a first side surface among the plurality of side surfaces has a first line that is a concave curve in a direction of the recess and a second line that is a straight line opposite the first line.

2. The secondary battery as claimed in claim 1, wherein the electrode assembly further includes:
a positive electrode lead tab that is in contact with the positive electrode plate and protrudes to the one side of the electrode assembly to protrude to the outside of the case; and
a negative electrode lead tab that is in contact with the negative electrode plate and protrudes to the one side of the electrode assembly to protrude to the outside of the case.

3. The secondary battery as claimed in claim 2, wherein in the case, the first side surface is a side surface facing a second side surface on which the positive electrode lead tab and the negative electrode lead tab protrude.

4. The secondary battery as claimed in claim 1, further comprising a folding portion between the case body portion and the case cover.

5. The secondary battery as claimed in claim 4, wherein the first side surface is a surface of the recess adjacent to the folding portion, and the second line is a part of the folding portion.

6. The secondary battery as claimed in claim 4, wherein the recess has a seating surface parallel to the case cover and four side surfaces extending from the seating surface toward the case cover, and the first line of the first side surface is a line that is in contact with the seating surface.

7. The secondary battery as claimed in claim 4, wherein the case body portion further includes a sealing portion extending outward from the recess provided in a center region and the sealing portion is parallel to and coupled to the case cover.

8. The secondary battery as claimed in claim 7, wherein the sealing portion extends in an outward direction from a second side surface, third side surface, and fourth side surface of the recess.

9. The secondary battery as claimed in claim 7, wherein the case cover is folded through the folding portion and coupled to the sealing portion.

10. The secondary battery as claimed in claim 6, wherein a second side surface, third side surface, and fourth side surface of the recess are flat surfaces.

11. The secondary battery as claimed in claim 1, wherein the first line is disposed on the lower side of the case body portion so as to face the case cover, and the second line is disposed at the same height as the sealing portions disposed on the edges of the plurality of side surfaces.

12. The secondary battery as claimed in claim 6, wherein the plurality of side surfaces include a second side surface facing the first side surface, a third side surface connecting the first side surface and the second side surface, and a fourth line facing the third side surface and connecting the first side surface and the second side surface.

13. The secondary battery as claimed in claim 1, wherein the first line and the electrode assembly accommodated in the recess are spaced apart from each other by a first distance, wherein the second line and the electrode assembly accommodated in the recess are spaced apart from each other by a second distance and wherein the first distance is smaller than the second distance.

14. The secondary battery as claimed in claim 1, wherein a center region of the first line includes a curve and wherein an edge region of the first line is a straight line.

15. The secondary battery as claimed in claim 1, wherein the electrode assembly is in the form of a jelly roll in which the positive electrode plate, the separator, the negative electrode plate, and the separator are stacked and then wound.

16. The secondary battery as claimed in claim 1, wherein the electrode assembly is a stacked electrode assembly in which the positive electrode plate, the separator, the negative electrode plate, and the separator are sequentially stacked.

17. The secondary battery as claimed in claim 2, wherein an insulating tape is interposed for insulating between the negative electrode lead tab and the case, and the insulating tape is interposed for insulating the positive electrode lead tab and the case from each other.

18. Manufacturing equipment for manufacturing the case of the secondary battery as claimed in claim 1, the manufacturing equipment comprising:
a die having a flat upper surface and an opening on an opposite side from the upper surface and having a rectangular shape in a plan view; and
a punch that can be inserted into the opening of the die and has a transition curve in a plan view.

19. The manufacturing equipment as claimed in claim 18, wherein the recess is formed by placing a rectangular film for a secondary battery case on the upper surface of the die and then pressing the same with the punch.

20. The manufacturing equipment as claimed in claim 19, wherein in the recess, the first line of the first side surface has a shape corresponding to a curved outer surface of the punch.
